(19) United States
(12) Patent Application Publication
(10) Pub. No.: US 2025/0219829 A1
(43) Pub. Date: Jul. 3, 2025

(54) CONTROL DEVICE, DATA TRANSMISSION SYSTEM AND OPERATION METHOD THEREOF

(71) Applicant: Nuvoton Technology Corporation, Hsinchu Science Park (TW)

(72) Inventor: Chi-Che MA, Pingtung County (TW)

(21) Appl. No.: 18/797,766

(22) Filed: Aug. 8, 2024

(30) Foreign Application Priority Data
Dec. 28, 2023 (TW) 112151190

(51) Int. Cl. H04L 9/14; H04L 9/32

(52) U.S. Cl. CPC H04L 9/14; H04L 9/3263

(57) ABSTRACT

A control device includes a storage unit, a key generation unit and a processing unit. The storage unit stores a control device certificate and a programming device certificate. The key generation unit generates a first private key. The key generation unit also generates a first public key according to the first private key. The processing unit receives the control device certificate and the programming device certificate according to the first public key and a device identification code. The processing unit stores the control device certificate and the programming device certificate in the storage unit.

### CROSS REFERENCE TO RELATED APPLICATIONS

This application claims priority of Taiwan Patent Application No. 112151190, filed on Dec. 28, 2023, the entirety of which is incorporated by reference herein.

### BACKGROUND OF THE INVENTION

### Field of the Invention

The present invention relates to a control device, and in particular it relates to a control device, a data transmission system, and an operation method thereof with a security data transmission.

### Description of the Related Art

For data transmission between a micro control unit (MCU) and a server, the internal part of the micro control unit or the server may not generate the key. This prevents the key from being leaked. In general, the user may use an additional smart card to generate the key.

However, this additional smart card may increase the cost of components and cause problems with key leakage. Therefore, how to effectively increase the security of data transmissions has become a focus of technical improvements.

### BRIEF SUMMARY OF THE INVENTION

An embodiment of the present invention provides a control device, a data transmission system, and an operation method thereof, thereby effectively increasing the security of data transmissions.

An embodiment of the present invention provides a control device, which includes a storage unit, a key generation unit and a processing unit. The storage unit is configured to store a control device certificate and a programming device certificate. The key generation unit is configured to generate a first private key, and to generate a first public key according to the first private key. The processing unit is configured to receive the control device certificate and the programming device certificate according to the first public key and a device identification code, and to store the control device certificate and the programming device certificate in the storage unit.

An embodiment of the present invention provides a data transmission system, which includes a control device, a programming device and a server device. The control device is configured to generate a first private key, generate a first public key according to the first private key, transmit the first public key and a device identification code, receive a control device certificate and a programming device certificate, and store the control device certificate and the programming device certificate. The programming device is configured to generate a second private key, generate a second public key according to the second private key, receive the first public key, generate a certificate signing request according to the first public key and the second public key, receive the control device certificate and the programming device certificate, store the programming device certificate, and transmit the control device certificate and the programming device certificate in the control device. The server device is configured to receive the certificate signing request to generate the control device certificate and the programming device certificate.

An embodiment of the present invention provides an operation method of a data transmission device, which includes the following steps. A control device is used to generate a first private key, generate a first public key according to the first private key, and transmit the first public key and a device identification code. A programming device is used to generate a second private key, generate a second public key according to the second private key, receive the first public key, and generate a certificate signing request according to the first public key and the second public key. A server device is used to receive the certificate signing request to generate a control device certificate and a programming device certificate. The programming device is used to receive the control device certificate and the programming device certificate, store the programming device certificate, and transmit the control device certificate and the programming device certificate to the control device. The control device is used to receive the control device certificate and the programming device certificate, and store the control device certificate and the programming device certificate.

According to the control device, the data transmission system and the operation method thereof disclosed by the present invention, the control device generates the first private key, generates the first public key according to the first private key, transmits the first public key and the device identification code, receives the control device certificate and the programming device certificate, and store the control device certificate and the programming device certificate. The programming device generates the second private key, generates the second public key according to the second private key, generates the certificate signing request according to the first public key and the second public key, receives the control device certificate and the programming device certificate, stores the programming device certificate, and transmits the control device certificate and the programming device certificate to the control device. The server device receives the certificate signing request to generate the control device certificate and the programming device certificate. Therefore, it may effectively increase the security of data transmission.

### BRIEF DESCRIPTION OF THE DRAWINGS

The present invention can be more fully understood by reading the subsequent detailed description and examples with references made to the accompanying drawings, wherein:

FIG. 1 is a schematic view of a control device according to an embodiment of the present invention;

FIG. 2 is a schematic view of a data transmission system according to an embodiment of the present invention;

FIG. 3 is a flowchart of an operation method of a data transmission system according to an embodiment of the present invention;

FIG. 4 is a flowchart of an operation method of a data transmission system according to another embodiment of the present invention; and

FIG. 5 is a flowchart of an operation method of a data transmission system according to another embodiment of the present invention.

### DETAILED DESCRIPTION OF THE INVENTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It should be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It should be acknowledged that although the terms “first”, “second”, “third”, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

In each of the following embodiments, the same reference number represents an element or component that is the same or similar.

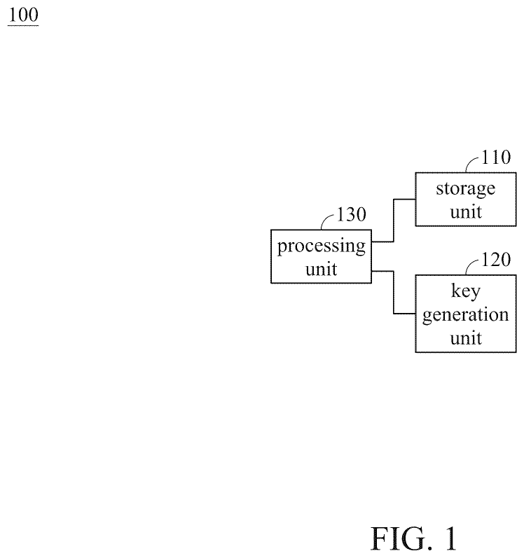

FIG. 1 is a schematic view of a control device n electronic device according to an embodiment of the present invention. In the embodiment, the control device 100 may be a micro control unit (MCU), such as a Cortex-M micro controller. Please refer to FIG. 1. The control device 100 may include a storage unit 110, a key generation unit 120 and a processing unit 130.

The storage unit 110 may store a control device certificate and a programming device certificate. In some embodiments, the storage unit 110 may be a non-volatile memory (NVM), such as a one-time programmable memory (OTP memory), but the embodiment of the present invention is not limited thereto.

The key generation unit 120 may generate a first private key and generate a first public key according to the first private key. In some embodiments, the key generation unit 120 generates the first private key through a true random number generator (TRNG), for example. In addition, the key generation unit 120 may include a key store, and the key store is used to store the first private key.

The processing unit 130 may receive the control device certificate and the programming device certificate according to the first public key and a device identification code, and store the control device certificate and the programming device certificate in the storage unit 110. That is, the processing unit 130 may transmit the first public key generated by the key generation unit 120 and the device identification code of the control device 100 to an external device. Then, the external device may generate the control device certificate and the programming device certificate according to the first public key and the device identification code, and transmit the control device certificate and the programming device certificate to the processing unit 130. Afterward, the processing unit 130 may store the control device certificate and the programming device certificate in the storage unit 110. Therefore, the authentication between the control device 100 and the external device may be completed, so as to increase the security of data transmission. In the embodiment, the device identification code is, for example, a unique identifier (UID).

In some embodiments, the processing unit 130 may further obtain a bootloader with a signature bootloader according to the device identification code. That is, the processing unit 130 may transmit the device identification code to the external device. Then, the external device may generate the bootloader according to the identification code, sign the bootloader to generate the signature bootloader, and provide the bootloader with the signature bootloader to the processing unit 130.

Afterward, the processing unit 130 may execute the above bootloader. Then, the key generation unit 120 and the external device may respectively use an algorithm to generate a shared session key to the processing unit 130 (the control device 100) and the external device. Afterward, the processing unit 130 may receive an encrypted application with the shared session key according to the shared session key. That is, the external device may use the shared session key to encrypt an application to generate the encrypted application, and provide the encrypted application to the processing unit 130. Afterward, the processing unit 130 may decrypt the encrypted application according to the shared session key to obtain the application and burn (install) the application.

In some embodiments, the processing unit 130 may further obtain a verification certificate and an application version according to the device identification code. That is, the processing unit 130 may transmit the device identification code to the external device. Then, the external device may generate the verification certificate and the application version according to the device identification code, and provide the verification certificate and the application version. Afterward, the key generation unit 120 and the external device may respectively generate a shared session key to the processing unit 130 (control device 100) and the external device. Then, the processing unit 130 may use the verification certificate to verify the control device certificate and use the application version to check the application. That is, the processing unit 130 may use the verification certificate to verify the control device certificate to determine whether the verification certificate matches the control device certificate, so as to determine the certificate is correct. In addition, the processing unit 130 may check the application according to the application version to determine a version state of the application.

Afterward, the processing unit 130 may receive an encrypted updating application with the shared session key according to the shared session key. That is, the external device may use the shared session key to encrypt the updating application to generate the encrypted updating application, and provide the encrypted updating application to the processing unit 130. Then, the processing unit 130 may decrypt the encrypted updating application according to the shared session key to obtain the updating application and burn (install) the updating application.

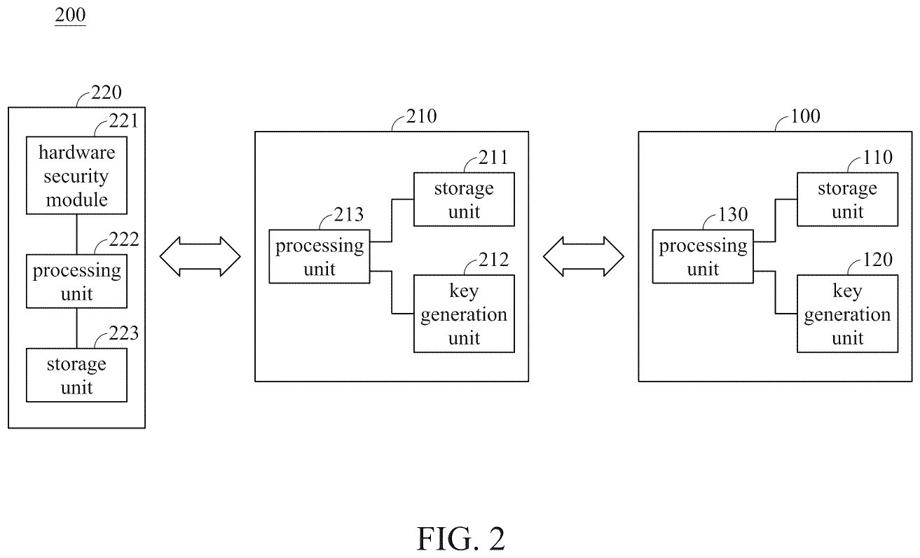

FIG. 2 is a schematic view of a data transmission system according to an embodiment of the present invention. Please to refer to FIG. 2. The data transmission system 200 includes a control device 100, a programming device 210 and a server device 220. In the embodiment, the control device 100 in FIG. 2 is the same as or similar to the control device 100 in FIG. 1. Accordingly, the control device 100 in FIG. 2 may refer to the description of the embodiment of FIG. 1, and the description thereof is not limited thereto.

The programming device 210 may generate a second private key, and generate a second public key according to the second private key. The programming device 210 may receive the first public key, and generate a certificate signing request (CSR) according to the first public key and the second public key. The programming device 210 may receive the control device certificate and the programming device certificate, store the programming device certificate, and transmit the control device certificate and the programming device certificate to the control device 100. In the embodiment, the programming device 210 may be a MCU, such as a Cortex-M55 micro controller.

Furthermore, the programming device 210 may include a storage unit 211, a key generation unit 212 and a processing unit 213. The storage unit 211 may store the programming device certificate. In some embodiments, the storage unit 211 may be a non-volatile memory, such as an OTP memory, but the embodiment of the present invention is not limited thereto.

The key generation unit 212 may generate the second private key, and generate the second public key according to the second private key. In some embodiments, the key generation unit 212 generates the second private key through a TRNG, for example. In addition, the key generation unit 212 may include a key store, and the key store is used to store the second private key.

The processing unit 213 may receive the first public key generated by the control device 100 (the processing unit 130). The processing unit 213 may generate the certificate signing request according to the first public key and the second public key. Then, the processing unit 213 may receive the control device certificate and the programming device certificate, store the programming device certificate to the storage unit 211, and transmit the control device certificate and the programming device certificate to the control device 100.

The server device 220 may receive the certificate signing request, and generate the control device certificate and the programming device certificate according to the certificate signing request. In the embodiment, the server device 220 may be a cloud server.

Furthermore, the server device 220 may at least include a hardware security module (HSM) 221, a processing unit 222 and a storage unit 223. The hardware security module 221 may receive the certificate signing request, and generate the control device certificate and the programming device certificate according to the certificate signing request. The processing unit 222 may transmit the control device certificate and the programming device certificate to the programming device. The storage unit 223 may store an application or an updating application, etc. Therefore, by storing the control device certificate and the programming device certificate in the control device 100 and storing the programming device certificate in the programming device 210, the authentication among the control device 100, the programming device 210 and the server device 220 may be completed, so as to increase the security of data transmission.

In some embodiments, the control device 100 (the processing unit 130) may transmit the device identification code to the programming device 210. The programming device 210 (the processing unit 211) may transmit the device identification code to the server device 220. The server device 220 (the hardware security module 221) may generate a third private key, a third public key, a fourth public key and a fourth private key according to the device identification code.

Then, the server device 220 (the processing unit 221) may sign a bootloader according to the third private key to generate a signature bootloader and sign an application according to the fourth private key to generate a signature application. Afterward, the server device 220 (the processing unit 221) may transmit the signature bootloader, the third public key, the signature application, the application, the bootloader and the fourth public key to the programming device 210.

The programming device 210 (the processing unit 211) may transmit the bootloader with the signature bootloader and the third public key to the control device 100. That is, the programming device 210 (the processing unit 211) uses the signature bootloader to process the bootloader, so as to generate the bootloader with the signature bootloader, and transmit the bootloader with the signature bootloader and the third public key to the control device 100.

Afterward, the control device 100 (the processing unit 130) may execute the above bootloader. Then, the programming device 210 (the key generation unit 212) and the control device 100 (the key generation unit 120) may respectively use an algorithm to generate a shared session key to the programming device 210 (the processing unit 211) and the control device 100 (the processing unit 130). Then, the programming device 210 (the processing unit 211) may attach the signature application and the fourth public key to the application and encrypt the application according to the shared session key to generate an encrypted application to the control device 100.

Afterward, the control device 100 (the processing unit 130) may decrypt the encrypted application according to the shared session key to obtain the application and burn (install) the application. Therefore, the security of data burning (installation) may be effectively increased.

In some embodiments, the server device 220 (the processing unit 221) may receive an updating application, and store the updating application in the storage unit 223. That is, the user may upload the updating application to the server device 220, so as to update the application of the control device 100.

Then, the control device 100 (the processing unit 130) may transmit the device identification code to the programming device 210. Afterward, the programming device 210 (the processing unit 211) may transmit the device identification code to the server device 220. Then, the server device 220 (the processing unit 211) may use a fourth private key to sign the above updating application according to the device identification code to generate a signature updating application. Afterward, the server device 220 (the processing unit 221) may transmit the signature updating application, the fourth private key, the updating application, an application version, a verification certificate and a fourth public key to the programming device 220.

Then, the programming device 210 (the key generation unit 212) and the control device 100 (the key generation unit 120) may respectively generate a shared session key to the programming device 210 (the processing unit 211) and the control device 100 (the processing unit 130). Afterward, the programming device 210 (the processing unit 211) may transmit the application version and the verification certificate to the control device 100. Then, the control device 100 (the processing unit 130) may use the verification certificate to verify the control device certificate and check the application according to the application version. That is, the control device 100 (the processing unit 130) may use the verification certificate to verify the control device certificate to determine whether the verification certificate matches the control device certificate, so as to determine the certificate is correct. In addition, the control device 100 (the processing unit 130) may check the application according to the application version to determine a version state of the application.

Afterward, the programming device 210 (the processing unit 210) may attach the signature updating application and the fourth public key to the updating application and encrypt the updating application according to the shared session key to generate an encrypted updating application to the control device 100. Then, the control device 100 (the processing unit 130) may decrypt the encrypted updating application according to the shared session key to obtain the updating application and burn (install) the updating application.

In some embodiments, the control device 100 and the programming device 210 may perform a data transmission using a first transmission protocol, and the programming device 210 and the server device 220 may perform a data transmission using a second transmission protocol, wherein the first transmission protocol is different from the second transmission protocol. In some embodiments, the above first transmission protocol may use, for example, an elliptic curve Diffie-Hellman (ECDH) protocol, so that the internal parts of the control device 100 and the programming device 210 are respectively generate the shared session key, so as to protect the transmission content between the control device 100 and the programming device 210. In addition, the above second transmission protocol may use, for example, a mutual transport layer security (mTLS) protocol.

In some embodiments, the programming device 210 and the server device 220 may communicate through a wired manner or a wireless manner. In the embodiment, the above wireless manner is, for example, a wireless fidelity (WiFi), but the embodiment of the present invention is not limited thereto. In addition, the control device 100 and the programming device 210 may communicate through a bus. In the embodiments, the above bus is, for example, a serial wire debug (SWD) bus, an universal asynchronous receiver/transmitter (UART) bus, an inter integrated circuit (I2C) bus, but the embodiment of the present invention is not limited thereto.

In some embodiments, before the data transmission system is used, the server device 220 and the programming device 210 may be loaded with the same advanced encryption standard key (AES key), such as AES_PACKAGE. For example, the advanced encryption standard key may be provided by the developer to the holder of the server device 220 and the programming device 210, and the holder loads the advanced encryption standard key into the server device 220 and the programming device 210, respectively. In addition, the advanced encryption standard key may be loaded into the hardware security module 221 of the server device 220 and the key generation unit 212 (key store) of the programming device 210, respectively.

In some embodiments, when the programming device 210 leaves the secure environment, the content of the programming device 210 may be protected and may not be read, so as to increase the security of use.

In some embodiments, the server device 220 may distribute the firmware identification code (firmware ID) of each application to be burned and the quantity limit to be burned corresponding to the firmware identification code, and the above firmware identification code and the above quantity limit transmitted from the server device 220 to the programming device may be protected by the advanced encryption standard key (AES_PACKAGE).

For example, the server device 220 may use encrypt the firmware identification code and the quantity limit through the advanced encryption standard key (AES_PACKAGE) to generate an encrypted message. Then, the server device 220 may transmit the encrypted message to the programming device 210. Furthermore, the server device 220 may transmit the above encrypted message to the holder of the programming device 210 through an Email. Afterward, the holder of the programming device 210 imports the encrypted message to the programming device 210. Then, the programming device 210 may decrypt the encrypted message through the advanced encryption standard key (AES_PACKAGE) to obtain the firmware identification code and the quantity limit, and store the firmware identification code and the quantity limit. For example, the firmware identification code and the quantity limit are stored in another storage unit (such as a flash memory) of the programming device 210. In addition, the above quantity limit may avoid excessive programming of firmware, so as to control the burning number of the control device 100.

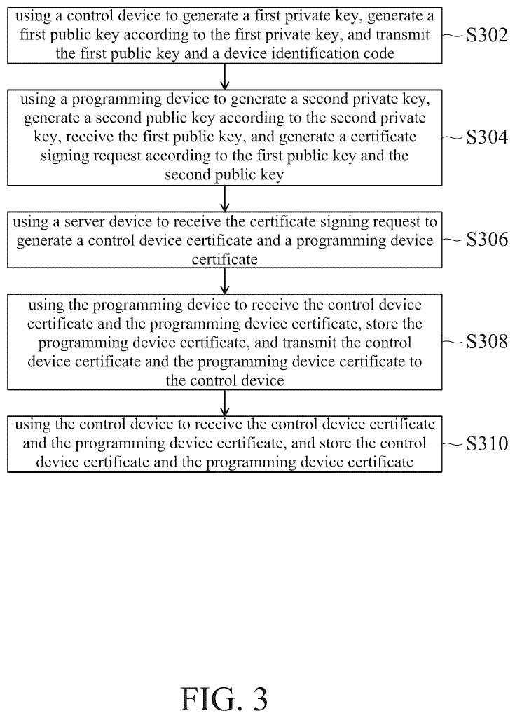

FIG. 3 is a flowchart of operation method of a data transmission device according to an embodiment of the present invention. In step S302, the method involves using a control device to generate a first private key, generate a first public key according to the first private key, and transmit the first public key and a device identification code. In step S304, the method involves using a programming device to generate a second private key, generate a second public key according to the second private key, receive the first public key, and generate a certificate signing request according to the first public key and the second public key.

In step S306, the method involves using a server device to receive the certificate signing request to generate a control device certificate and a programming device certificate. In step S308, the method involves using the programming device to receive the control device certificate and the programming device certificate, store the programming device certificate, and transmit the control device certificate and the programming device certificate to the control device. In step S310, the method involves using the control device to receive the control device certificate and the programming device certificate, and store the control device certificate and the programming device certificate.

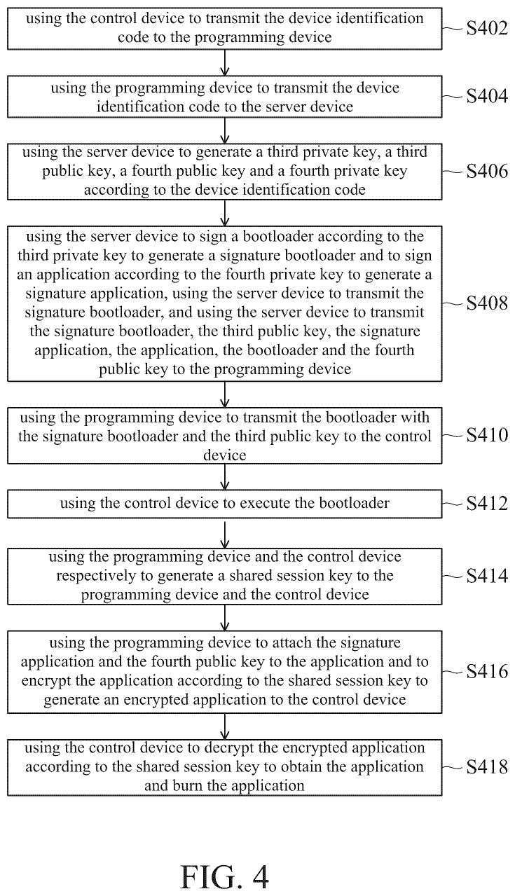

FIG. 4 is a flowchart of operation method of a data transmission device according to another embodiment of the present invention. The flowchart of the embodiment may follow step S310 in FIG. 3. In step S402, the method involves using the control device to transmit the device identification code to the programming device. In step S404, the method involves using the programming device to transmit the device identification code to the server device. In step S406, the method involves using the server device to generate a third private key, a third public key, a fourth public key and a fourth private key according to the device identification code.

In step S408, the method involves using the server device to sign a bootloader according to the third private key to generate a signature bootloader and to sign an application according to the fourth private key to generate a signature application, using the server device to transmit the signature bootloader, and using the server device to transmit the signature bootloader, the third public key, the signature application, the application, the bootloader and the fourth public key to the programming device. In step S410, the method involves using the programming device to transmit the bootloader with the signature bootloader and the third public key to the control device.

In step S412, the method involves using the control device to execute the bootloader. In step S414, the method involves using the programming device and the control device respectively to generate a shared session key to the programming device and the control device. In step S416, the method involves using the programming device to attach the signature application and the fourth public key to the application and to encrypt the application according to the shared session key to generate an encrypted application to the control device. In step S418, the method involves using the control device to decrypt the encrypted application according to the shared session key to obtain the application and burn the application.

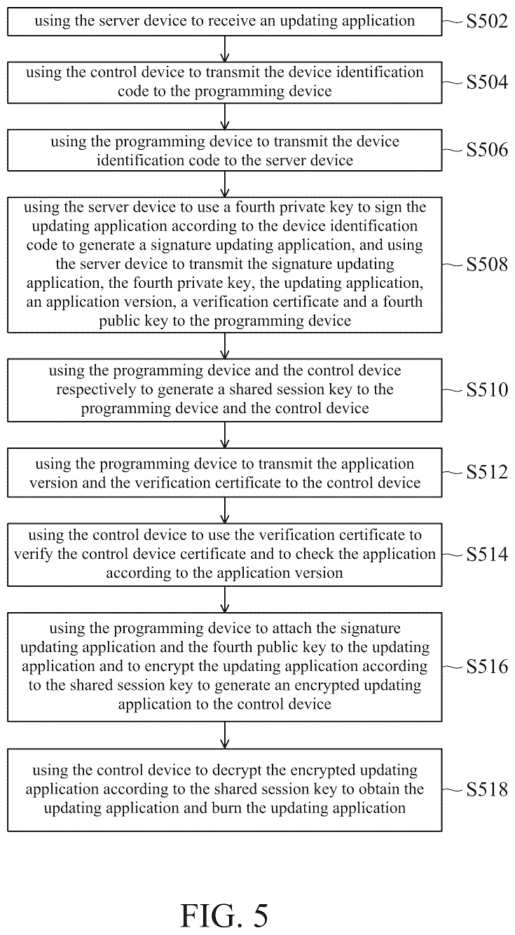

FIG. 5 is a flowchart of operation method of a data transmission device according to another embodiment of the present invention. The flowchart of the embodiment may follow step S310 in FIG. 3 or step S416 in FIG. 4. In step S502, the method involves using the server device to receive an updating application. In step S504, the method involves using the control device to transmit the device identification code to the programming device. In step S506, the method involves using the programming device to transmit the device identification code to the server device.

In step S508, the method involves using the server device to use a fourth private key to sign the updating application according to the device identification code to generate a signature updating application, and using the server device to transmit the signature updating application, the fourth private key, the updating application, an application version, a verification certificate and a fourth public key to the programming device. In step S510, the method involves using the programming device and the control device respectively to generate a shared session key to the programming device and the control device. In step S512, the method involves using the programming device to transmit the application version and the verification certificate to the control device.

In step S514, the method involves using the control device to use the verification certificate to verify the control device certificate and to check the application according to the application version. In step S516, the method involves using the programming device to attach the signature updating application and the fourth public key to the updating application and to encrypt the updating application according to the shared session key to generate an encrypted updating application to the control device. In step S518, the method involves using the control device to decrypt the encrypted updating application according to the shared session key to obtain the updating application and burn the updating application.

In summary, according to the control device, the data transmission system and the operation method thereof disclosed by the embodiment of the present invention, the control device generates the first private key, generates the first public key according to the first private key, transmits the first public key and the device identification code, receives the control device certificate and the programming device certificate, and store the control device certificate and the programming device certificate. The programming device generates the second private key, generates the second public key according to the second private key, generates the certificate signing request according to the first public key and the second public key, receives the control device certificate and the programming device certificate, stores the programming device certificate, and transmits the control device certificate and the programming device certificate to the control device. The server device receives the certificate signing request to generate the control device certificate and the programming device certificate. In addition, the control device, the programming device and the server device may respectively generate the private key, so as to ensure that the key may not be leaked. Furthermore, in the burning of the application or the updating application of the control device, the data and certificates may be transmitted among the control device, the programming device and the server device through the key. Therefore, the security of data transmission and data burning (installation) may be effectively increased

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control device, comprising:
a storage unit, configured to store a control device certificate and a programming device certificate;
a key generation unit, configured to generate a first private key, and to generate a first public key according to the first private key; and
a processing unit, configured to receive the control device certificate and the programming device certificate according to the first public key and a device identification code, and to store the control device certificate and the programming device certificate in the storage unit.

2. The control device as claimed in claim 1, wherein the processing unit is further configured to obtain a bootloader with a signature bootloader according to the device identification code, the processing unit is configured to execute the bootloader, the key generation unit is configured to generate a shared session key to the processing unit, the processing unit is configured to receive an encrypted application with the shared session key according to the shared session key, and the processing unit is configured to decrypt the encrypted application according to the shared session key to obtain an application and burn the application.

3. The control device as claimed in claim 1, wherein the processing unit is further configured to obtain a verification certificate and an application version according to the device identification code, the key generation unit is configured to generate a shared session key to the processing unit, the processing unit is configured to use the verification certificate to verify the control device certificate and is configured to use the application version to check the application, the processing unit is configured to receive an encrypted updating application with the shared session key according to the shared session key, and the processing unit is configured to decrypt the encrypted updating application according to the shared session key to obtain an updating application and to burn the updating application.

4. The control device as claimed in claim 1, wherein the storage unit is a one-time programmable memory.

5. The control device as claimed in claim 1, wherein the key generation unit comprises a key store configured to store the first private key.

6. A data transmission system, comprising:
a control device, configured to generate a first private key, generate a first public key according to the first private key, transmit the first public key and a device identification code, receive a control device certificate and a programming device certificate, and store the control device certificate and the programming device certificate;
a programming device, configured to generate a second private key, generate a second public key according to the second private key, receive the first public key, generate a certificate signing request according to the first public key and the second public key, receive the control device certificate and the programming device certificate, store the programming device certificate, and transmit the control device certificate and the programming device certificate to the control device; and
a server device, configured to receive the certificate signing request to generate the control device certificate and the programming device certificate.

7. The data transmission system as claimed in claim 6, wherein the control device is configured to transmit the device identification code to the programming device, the programming device is configured to transmit the device identification code to the server device, the server device is configured to generate a third private key, a third public key, a fourth public key and a fourth private key according to the device identification code, the server device is configured to sign a bootloader according to the third private key to generate a signature bootloader and the server device is further configured to sign an application according to the fourth private key to generate a signature application, the server device is configured to transmit the signature bootloader, the third public key, the signature application, the application, the bootloader and the fourth public key to the programming device, the programming device is configured to transmit the bootloader with the signature bootloader and the third public key to the control device, the control device is configured to execute the bootloader, the programming device and the control device are respectively configured to generate a shared session key to the programming device and the control device, the programming device is configured to attach the signature application and the fourth public key to the application and the programming device is configured to encrypt the application according to the shared session key to generate an encrypted application to the control device, and the control device is configured to decrypt the encrypted application according to the shared session key to obtain the application and to burn the application.

8. The data transmission system as claimed in claim 6, wherein the server device is configured to receive an updating application, the control device is configured to transmit the device identification code to the programming device, the programming device is configured to transmit the device identification code to the server device, the server device is configured to use a fourth private key to sign the updating application according to the device identification code to generate a signature updating application, the server device is configured to transmit the signature updating application, the fourth private key, the updating application, an application version, a verification certificate and a fourth public key to the programming device, the programming device and the control device are respectively configured to generate a shared session key to the programming device and the control device, the programming device is configured to transmit the application version and the verification certificate to the control device, the control device is configured to use the verification certificate to verify the control device certificate and the control device is further configured to check the application according to the application version, the programming device is configured to attach the signature updating application and the fourth public key to the updating application and the programming device is configured to encrypt the updating application according to the shared session key to generate an encrypted updating application to the control device, and the control device is configured to decrypt the encrypted updating application according to the shared session key to obtain the updating application and to burn the updating application.

9. The data transmission system as claimed in claim 6, wherein the control device and the programming device are configured to perform a data transmission using a first transmission protocol, the programming device and the server device are configured to perform a data transmission using a second transmission protocol, and the first transmission protocol is different from the second transmission protocol.

10. The data transmission system as claimed in claim 9, wherein the first transmission protocol uses an elliptic curve Diffie-Hellman protocol.

11. The data transmission system as claimed in claim 9, wherein the second transmission protocol uses a mutual transport layer security protocol.

12. The data transmission system as claimed in claim 6, wherein the control device comprises:
a storage unit, configured to store the control device certificate and the programming device certificate;
a key generation unit, configured to generate the first private key, and to generate the first public key according to the first private key; and
a processing unit, configured to transmit the first public key and the device identification code, receive the control device certificate and the programming device certificate, and store the control device certificate and the programming device certificate in the storage unit.

13. The data transmission system as claimed in claim 6, wherein the programming device comprises:
a storage unit, configured to store the programming device certificate;
a key generation unit, configured to generate the second private key, and generate the second public key according to the second private key; and
a processing unit, configured to receive the first public key, generate the certificate signing request according to the first public key and the second public key, receive the control device certificate and the programming device certificate, store the programming device certificate in the storage unit, and transmit the control device certificate and the programming device certificate to the control device.

14. The data transmission system as claimed in claim 6, wherein the server device comprises:
a hardware security module, configured to receive the certificate signing request to generate the control device certificate and the programming device certificate; and
a processing unit, configured to transmit the control device certificate and the programming device certificate to the programming device.

15. An operation method of a data transmission device, comprising:
using a control device to generate a first private key, generate a first public key according to the first private key, and transmit the first public key and a device identification code;
using a programming device to generate a second private key, generate a second public key according to the second private key, receive the first public key, and generate a certificate signing request according to the first public key and the second public key;
using a server device to receive the certificate signing request to generate a control device certificate and a programming device certificate;
using the programming device to receive the control device certificate and the programming device certificate, store the programming device certificate, and transmit the control device certificate and the programming device certificate to the control device; and
using the control device to receive the control device certificate and the programming device certificate, and store the control device certificate and the programming device certificate.

16. The operation method of the data transmission device as claimed in claim 15, further comprising:
using the control device to transmit the device identification code to the programming device;
using the programming device to transmit the device identification code to the server device;
using the server device to generate a third private key, a third public key, a fourth public key and a fourth private key according to the device identification code;
using the server device to sign a bootloader according to the third private key to generate a signature bootloader and to sign an application according to the fourth private key to generate a signature application, using the server device to transmit the signature bootloader, and using the server device to transmit the signature bootloader, the third public key, the signature application, the application, the bootloader and the fourth public key to the programming device;
using the programming device to transmit the bootloader with the signature bootloader and the third public key to the control device;
using the control device to execute the bootloader;
using the programming device and the control device respectively to generate a shared session key to the programming device and the control device;
using the programming device to attach the signature application and the fourth public key to the application and to encrypt the application according to the shared session key to generate an encrypted application to the control device; and
using the control device to decrypt the encrypted application according to the shared session key to obtain the application and to burn the application.

17. The operation method of the data transmission device as claimed in claim 15, further comprising:
using the server device to receive an updating application;
using the control device to transmit the device identification code to the programming device;
using the programming device to transmit the device identification code to the server device;
using the server device to use a fourth private key to sign the updating application according to the device identification code to generate a signature updating application, and using the server device to transmit the signature updating application, the fourth private key, the updating application, an application version, a verification certificate and a fourth public key to the programming device;
using the programming device and the control device respectively to generate a shared session key to the programming device and the control device;
using the programming device to transmit the application version and the verification certificate to the control device;
using the control device to use the verification certificate to verify the control device certificate and to check the application according to the application version;
using the programming device to attach the signature updating application and the fourth public key to the updating application and to encrypt the updating application according to the shared session key to generate an encrypted updating application to the control device; and
using the control device to decrypt the encrypted updating application according to the shared session key to obtain the updating application and to burn the updating application.

18. The operation method of the data transmission device as claimed in claim 15, wherein the control device and the programming device are configured to perform a data transmission using a first transmission protocol, the programming device and the server device are configured to perform a data transmission using a second transmission protocol, and the first transmission protocol is different from the second transmission protocol.

19. The operation method of the data transmission device as claimed in claim 18, wherein the first transmission protocol uses an elliptic curve Diffie-Hellman protocol.

20. The operation method of the data transmission device as claimed in claim 18, wherein the second transmission protocol uses a mutual transport layer security protocol.
